(19) United States
(12) Patent Application Publication
(10) Pub. No.: US 2022/0175085 A1
(43) Pub. Date: Jun. 9, 2022

(54) SOLE HAVING CARBON FIBER AND METHOD OF MANUFACTURING THE SAME

(71) Applicant: PADERSON SPORTING GOODS CO., LTD., TAICHUNG (TW)

(72) Inventor: Cheng-Ta HSU, TAICHUNG (TW)

(73) Assignee: PADERSON SPORTING GOODS CO., LTD., TAICHUNG (TW)

(21) Appl. No.: 17/136,761

(22) Filed: Dec. 29, 2020

(30) Foreign Application Priority Data
Dec. 4, 2020 (TW) 109142900

(51) Int. Cl. A43B 13/02; B32B 5/26; B32B 5/02; D03D 1/00; D03D 15/275

(52) U.S. Cl. CPC A43B 13/026; B32B 5/26; B32B 5/024; D03D 1/00; D10B 2501/043; B32B 2250/20; B32B 2262/106; B32B 2437/02; D10B 2101/12; D03D 15/275

(57) ABSTRACT

A sole includes a bottom layer and a carbon fiber layer. The bottom layer has at least two engaging portions. The carbon fiber layer is penetrated by at least two fitting holes. The at least two engaging portions are engaged with the at least two fitting holes, respectively. The diameter of the at least two fitting holes, which is close to the bottom layer, is less than the diameter of the at least two fitting holes closed to a upside surface of the carbon fiber layer. The at least two engaging portions undergo an injection process so as to be coupled to the at least two fitting holes, respectively, thereby reducing greatly the chance of injury which might otherwise happen to users as a result of separation of the bottom layer and the carbon fiber layer of the sole while the users are running quickly.

### BACKGROUND OF THE INVENTION

### 1. Technical Field

The present disclosure relates to soles and, more particularly, to a sole having carbon fiber and a method of manufacturing the same.

### 2. Description of the Related Art

Referring to FIG. 1 and FIG. 2, a sole 100 of a conventional shoe (for example, soccer shoe) essentially comprises a bottom layer 10 made of fiber and a carbon fiber layer 20. The carbon fiber layer 20 is penetrated by a fitting hole 21. The bottom layer 10 has an engaging portion 11. The engaging portion 11 of the bottom layer 10 undergoes an injection process so as to be coupled to the fitting hole 21 of the carbon fiber layer 20. With the carbon fiber layer 20 being highly resilient, every user wearing a conventional shoe with the sole 100 experiences minimal fatigue after a lengthy run.

However, the sole 100 is susceptible to wear and tear because of the user's lengthy run, especially because the bottom layer 10 and the carbon fiber layer 20 are coupled together through the fitting hole 21 rather than a means for coupling. As a result, separation of the bottom layer 10 and the carbon fiber layer 20 of the sole 100 is likely to occur while the user is running quickly, and in consequence the user is predisposed to injury.

Therefore, it is imperative to effectively enhance the structural stability of the sole and overcome the aforesaid drawback of the prior art.

### BRIEF SUMMARY OF THE INVENTION

It is an objective of the present disclosure to provide a sole having carbon fiber. The sole comprises a bottom layer and a carbon fiber layer. Fitting holes with step-shaped or serrate cross sections are disposed in the carbon fiber layer. Upon completion of injection and compression processes, engaging portions of the bottom layer correspond in position and shape and are coupled to the fitting holes of the carbon fiber layer, respectively, thereby reducing greatly the chance of injury which might otherwise happen to users as a result of separation of the bottom layer and the carbon fiber layer of the sole while the users are running quickly.

In order to achieve the above and other objectives, the present disclosure provides a sole comprising a bottom layer and a carbon fiber layer. The bottom layer has at least two engaging portions. The carbon fiber layer is penetrated by at least two fitting holes, such that the at least two engaging portions of the bottom layer correspond in position to and engage with the at least two fitting holes of the carbon fiber layer, respectively. Wherein the diameter of the at least two fitting holes, which is close to the bottom layer, is less than the diameter of the at least two fitting holes closed to a upside surface of the carbon fiber layer.

Preferably, the cross section of each fitting hole of the carbon fiber layer is step-shaped or serrate.

Preferably, the carbon fiber layer is formed by weaving carbon fiber yarns at 0 degree, 45 degrees, 60 degrees or 75 degrees through plain weave, twill weave or lamination, or the carbon fiber layer is formed by lamination of a predetermined number of layers of 3K carbon fiber fabrics.

In order to achieve the above and other objectives, the present disclosure further provides a sole comprising a bottom layer and a carbon fiber layer. The bottom layer has at least two engaging portions. The carbon fiber layer is penetrated by at least two fitting holes. The inner wall of each fitting hole concavely forms an embedded region. The at least two engaging portions of the bottom layer correspond in position to and engage with the embedded regions of the at least two fitting holes of the carbon fiber layer.

The present disclosure further provides a method of manufacturing a sole. The method comprises: step A, providing a base material comprising composite materials and then placing the base material in a compression mold to undergo a compression process, so as to form a bottom layer of predetermined dimensions; step B, providing a carbon fiber-containing material to form a carbon fiber layer by plain weave, twill weave or lamination; step C, placing the carbon fiber layer in a milling mold to undergo a milling process whereby at least two fitting holes are formed in the carbon fiber layer; and step D, placing the bottom layer and the carbon fiber layer in an injection molding machine to undergo an injection process, such that at least two engaging portions are formed on the bottom layer, allowing the at least two engaging portions of the bottom layer to correspond in position to and thus be coupled to the at least two fitting holes of the carbon fiber layer, respectively, wherein the carbon fiber layer is formed on the bottom layer.

Fine structures, features, assembly or operation of the sole and a method of manufacturing the same, provided according to the present disclosure, are illustrated by embodiments and described below. However, persons skilled in the art understand that the description below and the specific embodiments are illustrative of the present disclosure rather than restrictive of the claims of the present disclosure.

### BRIEF DESCRIPTION OF THE SEVERAL VIEWS OF THE DRAWINGS

FIG. 1 (PRIOR ART) is a schematic perspective view of a conventional sole.

FIG. 2 is a schematic cross-sectional view taken along line 2-2 of FIG. 1.

FIG. 3 is a schematic perspective view of a sole according to the first preferred embodiment of the present disclosure.

FIG. 4 is a schematic cross-sectional view of the sole of FIG. 3.

FIG. 5 is a schematic cross-sectional view of another sole according to the second preferred embodiment of the present disclosure.

FIG. 6 is a schematic cross-sectional view of yet another sole according to the third preferred embodiment of the present disclosure.

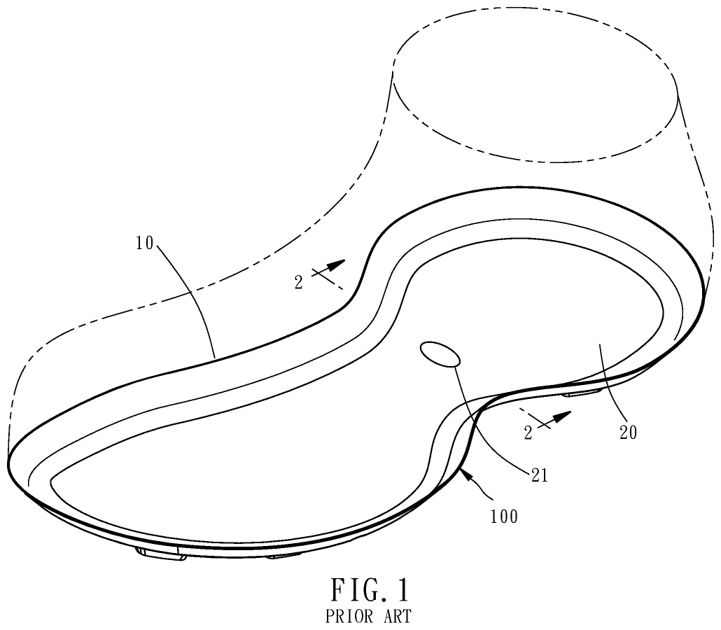

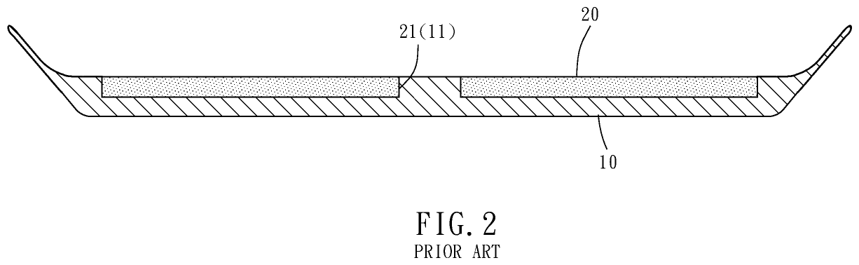

### DETAILED DESCRIPTION OF THE INVENTION

Directional expressions used herein, including the description of embodiments and claims, must be interpreted in accordance with the accompanying drawings. Identical reference numerals used in the embodiments and the accompanying drawings denote identical or similar components or structural features thereof.

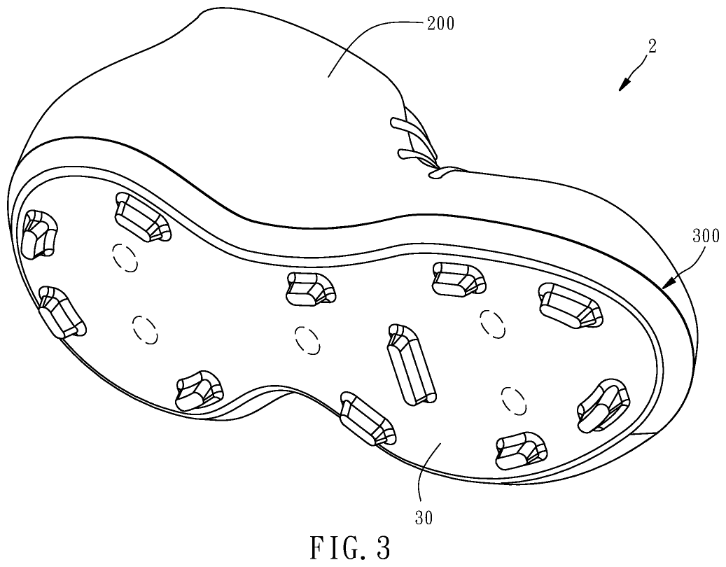

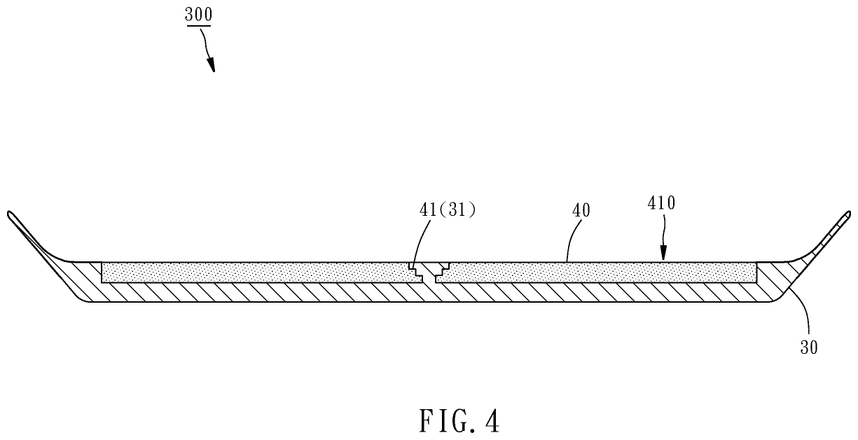

Referring to FIG. 3 and FIG. 4, a sole 300 is provided according to the first preferred embodiment of the present disclosure. The sole 300 is suitable for use in a shoe 2. The shoe 2 further comprises an upper 200. The sole 300 essentially comprises a bottom layer 30 and a carbon fiber layer 40. In this embodiment, the bottom layer 30 is made of a conventional material, such as rubber, PU, PVC, EVA, TPR, SBS and any other polymeric composite material. The carbon fiber layer 40 is made of thermoplastic carbon fiber or thermosetting carbon fiber. Five spaced-apart engaging portions 31 protrude toward the carbon fiber layer 40 from the bottom layer 30. The five engaging portions 31 of the bottom layer 30 correspond in position and shape to five fitting holes 41 which penetrate the carbon fiber layer 40, respectively, such that the five engaging portions 31 of the bottom layer 30 undergo an injection process so as to be coupled to the five fitting holes 41 of the carbon fiber layer 40, respectively. The diameter of the fitting holes 41, which is close to the bottom layer 30, is less than the diameter of the fitting holes 41 closed to a upside surface 410 of the carbon fiber layer 40. Preferably, cross sections of the fitting holes 41 of the carbon fiber layer 40 are step-shaped. Preferably, the fitting holes 41 of the carbon fiber layer 40 are in the number of two or more. The carbon fiber layer 40 is formed by weaving carbon fiber yarns at 0 degree, 45 degrees, 60 degrees or 75 degrees through plain weave, twill weave or lamination according to the prior art, and thus details are not reiterated herein. The carbon fiber layer 40 is formed by lamination of a predetermined number (for example, 2, 3, 4, 5 or more, which is subject to changes as needed) of layers of 3K carbon fiber fabrics.

The sole 300 provided according to the first preferred embodiment of the present disclosure has advantages described below. The bottom layer 30 and the carbon fiber layer 40 of the sole 300 are firmly coupled together through the five engaging portions 31 of the bottom layer 30 and the five fitting holes 41 of the carbon fiber layer 40. The cross sections of the five fitting holes 41 are step-shaped. The five engaging portions 31 undergo an injection process so as to be coupled to the five fitting holes 41 to attain substantially conical configurations, respectively, thereby reducing greatly the chance of injury which might otherwise happen to users as a result of separation of the bottom layer 30 and the carbon fiber layer 40 of the sole 300 while the users are running quickly.

The first preferred embodiment of the present disclosure further discloses a method of manufacturing a sole 300 of a shoe 2. The steps of the method are described below.

Step A, providing a base material which contains polymeric composite materials (in this embodiment, which serves an exemplary purpose, the base material is composed of various polymeric composite materials, such as rubber, PU, PVC, EVA, TPR, and SBS), and then placing the base material in a compression mold to undergo a compression process, so as to form the bottom layer 30 of predetermined dimensions and the five engaging portions 31 protruding from the surface of the bottom layer 30. In this embodiment, upon completion of the compression process, the engaging portions 31 of the bottom layer 30 are in the number of two or more as needed.

Step B, providing a carbon fiber-containing material to form the carbon fiber layer 40 by weaving carbon fiber yarns at 0 degree, 45 degrees, 60 degrees or 75 degrees through plain weave, twill weave or lamination. Alternatively, the carbon fiber layer 40 is formed by lamination of a predetermined number (for example, 2, 3, 4, 5 or more, which is subject to changes as needed) of layers of 3K carbon fiber fabrics.

Step C, placing the carbon fiber layer 40 in a milling mold to undergo a milling process whereby five fitting holes 41 with step-shaped cross sections are formed in the carbon fiber layer 40. In this embodiment, the five fitting holes 41 of the carbon fiber layer 40 take on the step-shaped cross sections with a milling cutter of a special shape. In this embodiment, upon completion of the milling process, the fitting holes 41 of the carbon fiber layer 40 are in the number of two or more as needed.

Step D, placing the bottom layer 30 and the carbon fiber layer 40 in an injection molding machine to undergo a secondary injection molding process, such that the five engaging portions 31 of the bottom layer 30 can be coupled to the five fitting holes 41 of the carbon fiber layer 40, respectively, wherein the carbon fiber layer 40 is formed on the bottom layer 30. In this step, the injection molding machine has its temperature set to range from 130° C. to 170° C., its pressure set to range from 30 kg/cm² to 70 kg/cm², and its time set to range from 10 minutes to 20 minutes. In this step, preferably, the injection molding machine has its temperature set to 150° C., its pressure to 50 kg/cm², and its time to 15 minutes.

Step E, taking the sole 300 out of the injection molding machine and trimming the burrs of the sole 300.

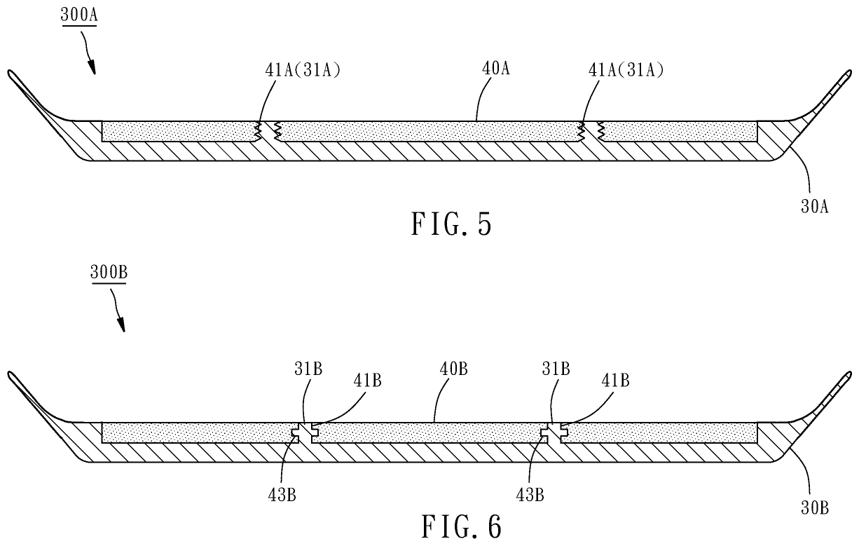

Referring to FIG. 5, a sole 300A is provided according to the second preferred embodiment of the present disclosure. The sole 300A in the second preferred embodiment is substantially identical to its counterpart in the first preferred embodiment in terms of structure. The sole 300A in the second preferred embodiment essentially comprises a fiber-containing bottom layer 30A and a carbon fiber layer 40A. The carbon fiber layer 40A is made of thermoplastic carbon fiber or thermosetting carbon fiber. At least two spaced-apart engaging portions 31A protrude toward the carbon fiber layer 40A from the bottom layer 30A. The at least two engaging portions 31A of the bottom layer 30A correspond in position and shape to at least two fitting holes 41A penetrating the carbon fiber layer 40A, respectively, such that the at least two engaging portions 31A of the bottom layer 30A undergo an injection process whereby the at least two engaging portions 31A of the bottom layer 30A are coupled to the fitting holes 41A of the carbon fiber layer 40A, respectively. The technical features and advantages of each structural layers of the sole 300A in the second preferred embodiment are identical to those of its counterpart in the first preferred embodiment and thus are not reiterated herein, except for the distinguishing technical features as follows: the wall of each fitting hole 41A of the carbon fiber layer 40A is rendered serrate by the milling process; both the bottom layer 30A and the carbon fiber layer 40A are placed in an injection molding machine to undergo a secondary injection molding process whereby the at least two engaging portions 31A of the bottom layer 30A are coupled to the at least two fitting holes 41A of the carbon fiber layer 40A, respectively.

Referring to FIG. 6, a sole 300B suitable for use in a shoe is provided according to the third preferred embodiment of the present disclosure. The sole 300B in the third preferred embodiment is substantially identical to its counterparts in the first and second preferred embodiments in terms of structure and is composed of a fiber-containing bottom layer 30B and a carbon fiber layer 40B. The carbon fiber layer 40B is made of thermoplastic carbon fiber or thermosetting carbon fiber. At least two spaced-apart engaging portions 31B protrude toward the carbon fiber layer 40B from the bottom layer 30B. The at least two engaging portions 31B of the bottom layer 30B correspond in position and shape to at least two fitting holes 41B penetrating the carbon fiber layer 40B, respectively, such that the at least two engaging portions 31B of the bottom layer 30B are coupled to the fitting holes 41B of the carbon fiber layer 40B by an injection process, respectively. The technical features and advantages of each structural layers of the sole 300B in the third preferred embodiment are identical to those of its counterparts in the first and second preferred embodiments and thus are not reiterated herein, except for the distinguishing technical features as follows: the inner wall of each fitting hole 41B of the carbon fiber layer 40B undergoes the milling process and thus concavely forms a ring-shaped embedded region 43B; both the bottom layer 30B and the carbon fiber layer 40B are placed in an injection molding machine to undergo a secondary injection molding process whereby at least two engaging portions 31B of the bottom layer 30B are coupled to the ring-shaped embedded regions 43B of the at least two fitting holes 41B of the carbon fiber layer 40B, respectively. The embedded regions 43B of the fitting holes 41B of the carbon fiber layer 40B are in a plural number and are spaced apart from each other.

Fine structures, features, assembly or operation of the sole and a method of manufacturing the same, provided according to the present disclosure, are illustrated by embodiments and described below. However, persons skilled in the art understand that the description below and the specific embodiments are illustrative of the present disclosure rather than restrictive of the claims of the present disclosure.

What is claimed is:

1. A sole, comprising:
a bottom layer and a carbon fiber layer, the bottom layer having at least two engaging portions, and the carbon fiber layer being penetrated by at least two fitting holes, wherein the at least two engaging portions of the bottom layer correspond in position to and engage with the at least two fitting holes of the carbon fiber layer, respectively, wherein the diameter of the at least two fitting holes, which is close to the bottom layer, is less than the diameter of the at least two fitting holes closed to a upside surface of the carbon fiber layer.

2. A sole, comprising:
a bottom layer and a carbon fiber layer, the bottom layer having at least two engaging portions, and the carbon fiber layer being penetrated by at least two fitting holes, with an embedded region concavely formed on an inner wall of each said fitting hole, wherein the at least two engaging portions of the bottom layer correspond in position to and engage with the embedded regions of the at least two fitting holes of the carbon fiber layer, respectively.

3. The sole of claim 1, wherein cross sections of the fitting holes of the carbon fiber layer are step-shaped or serrate.

4. The sole of claim 1, wherein the carbon fiber layer is formed by weaving carbon fiber yarns at 0 degree, 45 degrees, 60 degrees or 75 degrees through plain weave, twill weave or lamination.

5. The sole of claim 4, wherein the carbon fiber layer is formed by lamination of a predetermined number of layers of 3K carbon fiber fabrics.

6. The sole of claim 2, wherein the carbon fiber layer is formed by weaving carbon fiber yarns at 0 degree, 45 degrees, 60 degrees or 75 degrees through plain weave, twill weave or lamination.

7. The sole of claim 6, wherein the carbon fiber layer is formed by lamination of a predetermined number of layers of 3K carbon fiber fabrics.

8. The sole of claim 3, wherein the carbon fiber layer is formed by weaving carbon fiber yarns at 0 degree, 45 degrees, 60 degrees or 75 degrees through plain weave, twill weave or lamination.

9. The sole of claim 8, wherein the carbon fiber layer is formed by lamination of a predetermined number of layers of 3K carbon fiber fabrics.

10. A method of manufacturing a sole, the method comprising:
step A, providing a base material comprising composite materials and then placing the base material in a compression mold to undergo a compression process, so as to form a bottom layer of predetermined dimensions;
step B, providing a carbon fiber-containing material to form a carbon fiber layer by plain weave, twill weave or lamination;
step C, placing the carbon fiber layer in a milling mold to undergo a milling process whereby at least two fitting holes are formed in the carbon fiber layer; and
step D, placing the bottom layer and the carbon fiber layer in an injection molding machine to undergo an injection process, such that at least two engaging portions are formed on the bottom layer, allowing the at least two engaging portions of the bottom layer to correspond in position to and thus be coupled to the at least two fitting holes of the carbon fiber layer, respectively, wherein the carbon fiber layer is formed on the bottom layer.

11. The method of claim 10, wherein, in step C, cross sections of the at least two fitting holes of the carbon fiber layer are step-shaped or serrate.

12. The method of claim 10, wherein, in step C, a wall of each said fitting hole of the carbon fiber layer concavely forms an embedded region.

13. The method of claim 10, wherein, in step D, pressure of the injection molding machine is set to range from 30 kg/cm² to 70 kg/cm².

14. The method of claim 13, wherein, in step D, temperature of the injection molding machine is set to range from 130° C. to 170° C.
